(19) United States
(12) Patent Application Publication
(10) Pub. No.: US 2010/0257448 A1
(43) Pub. Date: Oct. 7, 2010

(54) Object-Based Interactive Programming Device and Method

(75) Inventor: Douglas Squires, Cedar Grove, NJ (US)

Correspondence Address: Law Office of Michael J. Feigin, 103 The Circle, (http://PatentLawNY.com), Passaic, NJ, 07055, US

(73) Assignee: Interactical LLC, Cedar Grove, NJ (US)

(21) Appl. No.: 12/418,670

(22) Filed: Apr. 6, 2009

(51) Int. Cl. G06F 3/048; H04N 5/445

(52) U.S. Cl. 715/717; 725/37; 386/95

(57) ABSTRACT

The disclosed technology proceeds by placing an indicator on an object in a live action or pre-recorded video. The indicator may be placed on the object throughout a segment of the video manually, or with the aid of a computer-aided tracking program, sensor (e.g. satellite navigation system), or the like. The indicator is selectable. An example of such is where a user of a video receiving device uses a remote control to toggle through indicators displayed on screen and selects an indicator to receive more information on a person displayed on screen.

### FIELD OF THE DISCLOSED TECHNOLOGY

The disclosed technology relates generally to interactive media and, more specifically, to selectable objects in an interactive media display.

### BACKGROUND OF THE DISCLOSED TECHNOLOGY

There is a demand for greater interactivity from viewers of television programs, internet recordings or broadcasts, and stored media (DVD, DVR, etc.). Current technology allows for limited viewer activity, where the viewer can control certain aspects of a live broadcast or recorded movie. For example, a viewer of a football game may be able to view different camera angles of the game he is watching. What is absent is an efficient way for viewers to get data relevant to specific elements present in the video itself.

### SUMMARY OF THE DISCLOSED TECHNOLOGY

It is an object of the disclosed technology to provide interactivity with individual objects (including people) in a broadcast or recorded video.

A method of providing interactive videos comprises exhibiting at least one selectable indicator at a position of an object displayed in a motion video, receiving a selection of an exhibited selectable indicator, and exhibiting data associated with the object. The motion video may be a live broadcast, in which case the indicator may be positioned on the motion video based on location data received from a sensor on the object. In this manner, the process of providing indicators during a live broadcast may be, at least, semi-automated, such as with the use of proximity sensors, infrared sensors, a satellite navigation system, RFID (radio frequency identification), or the like. The motion video may also be a recorded video, and in such a case, the indicator placement may be based on manual tracking of the object and/or via computer-aided tracking of the object.

A step of providing a choice of associated data types before exhibiting the data associated with the object may be carried out. For example, a viewer may select to view one or more kinds of data types of biographical information, player statistics, photographs, salable items, and web pages.

The at least one indicator may be a plurality of indicators. Each indicator is at a position of a respective object, and a subset of the plurality of indicators may be displayed based on a data type available for each respective object. Or, the subset of indicators displayed may be based on an object classification, e.g., only show indicators for the umpires, the offensive team, the defensive team, or the quarterbacks in a football game, or the main actors, all actors, movable items, or the like in a movie.

The (selectable) indicator may surround at least a part of the object, or may be placed on the object.

A device of the disclosed technology is an interactive video receiving device, that is, a device such as a digital video player, television, cable or satellite TV receiver, TV set-top box, or the like, which comprises a signal input (e.g., signal input from a satellite dish, coaxial cable, or laser reading the pits of an optical disc) and signal output device (e.g., video output to a television set or networked device) for a video signal, even if internal to the device itself (e.g., a television with built in signal input means and signal output means).

A received video input signal is propagated with at least one selectable indicator at a position of an object displayed in the motion video. The selectable indicator position, display, or associated characteristics may be propagated with the video signal via the video input itself, or received via a separate data channel. The video device further comprises an input configured to receive a selection of at least one selectable indicator. A display (such as a display on a television screen, personal computer, or integrated with the disclosed device) is then configured to exhibit data associated with the object. Based on the above features of the device, functions which have been disclosed with the method of the disclosed technology may be carried out in part or in whole by the video receiving device.

### BRIEF DESCRIPTION OF THE DRAWINGS

FIG. 1 is an example of a video output from a device used to carry out an embodiment of the disclosed technology showing selectable outlines and point indicators on objects.

FIG. 2 is an inverted screenshot of the example shown in FIG. 1.

FIG. 3 shows a table comprising sample location data used to place indicators on an object in a video feed in embodiments of the disclosed technology.

FIG. 4 shows the steps taken to display selectable indicators on a video feed in embodiments of the disclosed technology.

FIG. 5 shows the steps taken to receive a selection of a subset of indicators in an embodiment of the disclosed technology.

FIG. 6 shows the steps taken to receive data associated with an object in an embodiment of the disclosed technology.

FIG. 7 is an example of a video output from a device used to carry out an embodiment of the disclosed technology showing a menu choice of data associated with a selectable object.

FIG. 8 shows a high level block diagram of an interactive video receiving device on which embodiments of the disclosed technology may be carried out.

FIG. 9 shows a high-level block diagram of a computer that may be used to carry out the disclosed technology.

### DETAILED DESCRIPTION OF EMBODIMENTS OF THE DISCLOSED TECHNOLOGY

Embodiments of the disclosed technology place an indicator (such as a point, a shape, or an outline) on at least one object displayed in a live action or pre-recorded video. The position of the indicators is determined based on received data, such as in a separate data feed, or with the video feed itself. Such a feed may receive data from satellite navigation systems (e.g., global positioning systems), RFID, proximity sensors, and the like, to determine a position of an object, such as a person, in a motion (moving) video display, relative to the video capturing device. Alternatively, such data may be provided after the video is produced by a manual or computer-aided tracking of an object in a video sequence. The indicator is selectable. An example of such is where a user of a video receiving device (e.g., a video propagation device such as a cable or satellite transceiver, video disc player [DVD, Blu-Ray, etc.], computer, or television) of the disclosed technology uses a remote control to toggle through the indicators on screen and can select an indicator. Selecting such an indicator allows the user to receive data associated with the object selected, e.g., statistics on a player in a sporting event, data allowing for the ability to purchase items related to the selected object, biographical information, and so forth.

Embodiments of the disclosed technology will become clearer in light of the description of the figures.

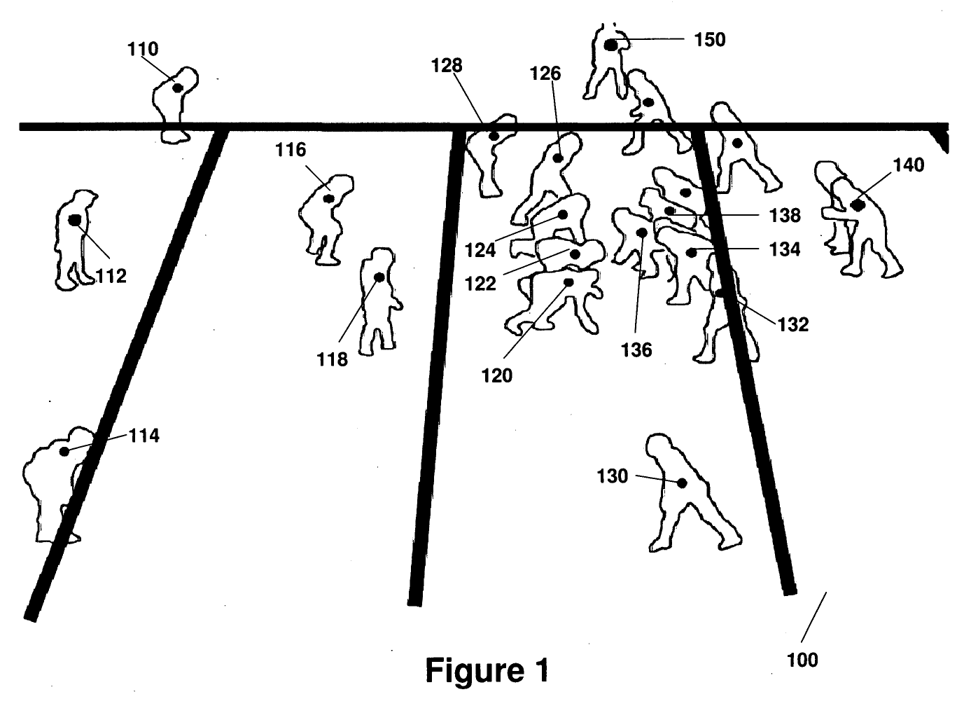

FIG. 1 is an example of a video output from a device used to carry out an embodiment of the disclosed technology showing selectable outlines and point indicators on objects. It should be understood that for the sake of clarity in this disclosure, a still, line art drawing is being used in place of an actual video of the sporting event shown in the figure. In the example of FIG. 1, a football game is being played between two teams on a field 100. The defensive team is on the left and offensive team is on the right. Those in the defensive secondary (e.g., away from the line of scrimmage/where the ball was lost or stopped) are players 110, 112, 114, 116, and 118 who are marked with respective indicators. Those near the line of scrimmage on the defensive team are players 120, 122, 124, 126, and 128. On the offensive side, the forward players are players 130, 132, 134, 136, and 138 (other selectable indicators/players are not numbered for the sake of brevity). In the offensive backfield is player 140. The referee 150 is further tagged with an indicator in this example. Each indicator, or a subset thereof, is selectable using a device such as a television remote control (e.g., arrow keys), a mouse, touch screen, or the like. In embodiments of the disclosed technology, the indicators are invisible to the user, such as when a certain object is not presently selected or in conjunction with a touch-screen or other similar device whereby a user can touch the object about which more information is desired. An invisible indicator is an indicator which is selectable, but does not alter the video output. Selecting an object such as a player, as will be shown below, allows the viewer to receive data specific to (associated with) the object which has been selected. As such, the video viewing experience becomes interactive, personal, and tied to what is currently being shown in the video footage.

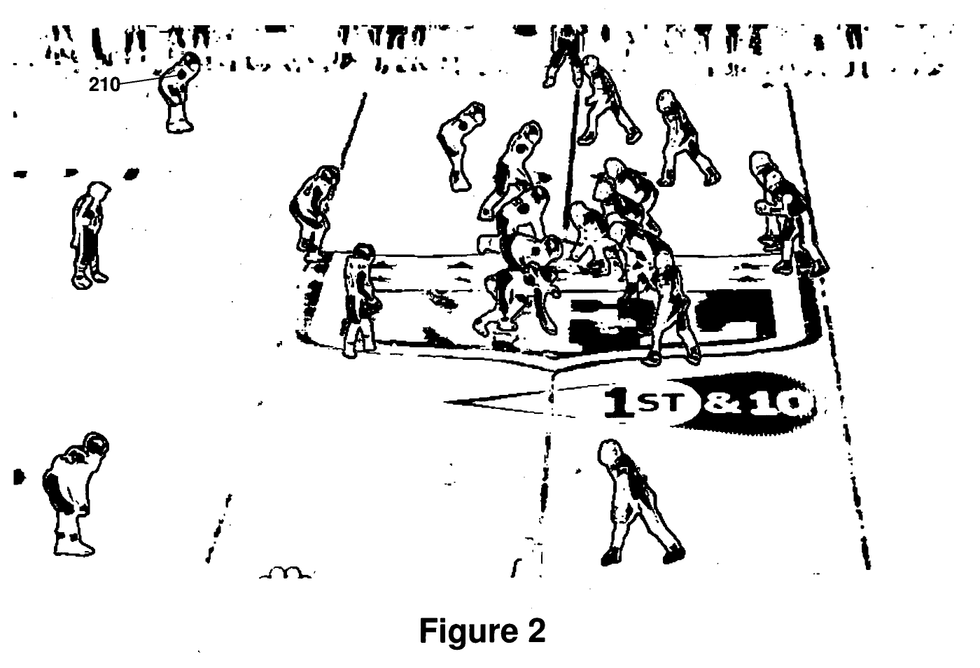

FIG. 2 is an inverted screenshot of the example shown in FIG. 1. The screenshot of a video frame shown on a display device (e.g., television, LCD screen, etc.) has been converted black and white and inverted from the original for maximum visibility in this disclosure. Player 210, corresponding to player 110 of FIG. 1, has been labeled; however, again, this is for purposes of this disclosure. As can been seen in this screenshot of a video output as placed on a display, a point is present on the player 210 in the video. The point may, for example, be drawn in a color which is high contrast to the background around it or surrounded with a clearly visible border, etc. For example, on a red jersey, the point may be green or yellow. Similarly, an outline view may be used instead and a viewer may be given an option, where available, to switch between desired indicators, e.g., selecting between outlining objects and placing a point or dot over the object such as player 210. Substantially any indicator, whether a point, shape, outline or combination thereof may be used. The indicator, however, in embodiments of the disclosed technology, must indicate to a viewer that an object in a video feed is selectable, e.g., a person who sees the indicator in a video feed will understand that the indicator is associated with a specific object and that, by selecting the indicator, the object will be “selected,” such as a player in a field, an actor in a movie, or a specific vacuum cleaner in a display of vacuum cleaners for sale on a home shopping network or commercial.

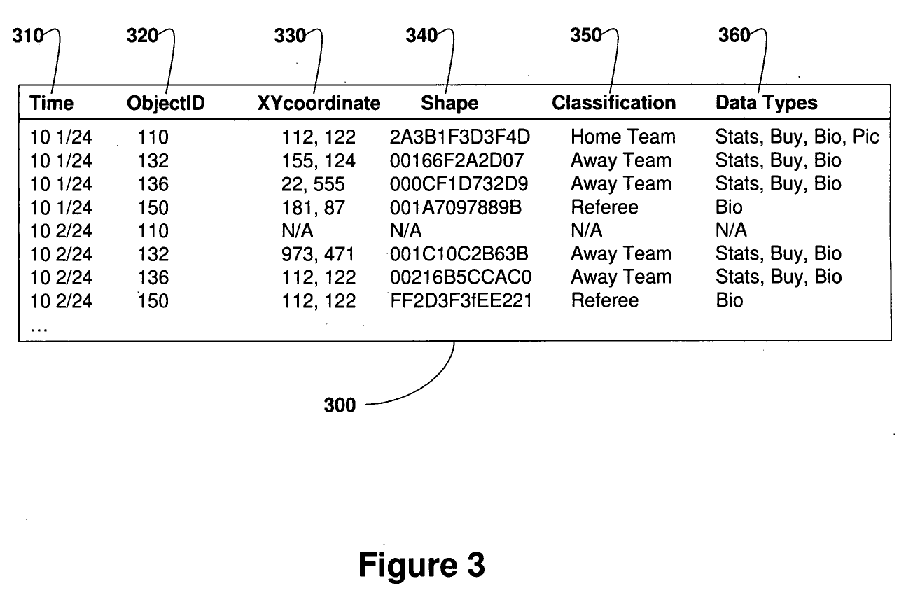

FIG. 3 shows a table comprising sample location data used to place indicators on an object in a video feed in embodiments of the disclosed technology. Such data may be provided substantially in real-time (e.g., at the same time as or before a video feed of a live event is provided) to a viewer and/or may be encoded on a storage medium for a video, such as on optical or magnetic media storing video data.

Additionally, such data may be provided separately, and may, for example be a separate overlay that a viewer can purchase or use, such as to overlay a video which does not comprise such data. For example, in an embodiment of the disclosed technology, a user may download such data from a website or be provided with such data as part of an online video watching experience. In the former example, a user may watch a VHS or DVD video of the 1987 20^{th} Century Fox movie, “The Princess Bride” bought at any store, and download overlay data, such as that shown in FIG. 3, to mark up the video as it plays and receive additional content. For example, when actor Peter Falk first comes on to the screen, using the location data (and time markup data), a button saying, “Peter Falk's biography” may appear over Peter Falk, or simply, an indicator such as a red dot may appear and be selectable for a few seconds (or be turned on and off at the decision of a user). In another example, a user may watch the Monty Python comedy, “The Holy Grail” via a streaming video. During scene 21, when the killer rabbit is on screen, an indicator may be placed on the rabbit, and when selected, associated content is exhibited, such as a link to purchase the killer rabbit, or critical reviews of the killer rabbit character. A menu may be used to allow the viewer to select from such options.

Referring again to FIG. 3, the data table 300 comprises a sampling of data which may be used to properly display the indicator. Such data may be streamed from a disc, be part of a video feed, or provided separately. Time 310 is a timestamp of when the data is applicable. In the example shown in FIG. 3, assuming 24 frames per second, the time has been indicated as “10 1/24” and “10 2/24” for two frames. Thus, in the frame displayed at 10 and 1/24 seconds from the beginning of the broadcast, for object 110, the XY coordinate 330 is 112, 122. If the data is received or processed only after the video display, it is dropped or ignored. ObjectID 320 refers to a specific object which is to receive an indicator placed over or around it (the label numbers from FIG. 1 have been used in this example for convenience). The XY coordinate 330 refers to the position on the X and Y axis in the video feed where the center of the object or place of indicator should be drawn. Each frame may be broken up into pixels, inches, or another measure, and the coordinate is provided within an XY plane.

The shape data 340 is computer-interpretable data indicating the shape of the object for purposes of drawing a selectable outline around the object. (The shape data may instead be simply instructions for what type of indicator to try, e.g., point, circle, square, red, blue, green, etc.) The (object) classification 350 is a classification of what type of object is being displayed. For example, as shown in FIG. 3, object 110 is classified as being part of the “home team” and object 150 is classified as being a “referee.” In this manner, a user such as a viewer can decide which indicators to show on the video feed. During a football game, for example, the user may desire to see only indicators for the home team, only those who are currently on the field (e.g., no indicators for those sitting on the bench), and so forth. In a movie, for example, a user, such as a viewer, may only desire to have indicators shown for the major actors, the minor actors, the female actresses, the male actors, objects in the background, objects in the foreground, and so on and so forth. Any reasonable classification scheme for the objects may be used and sent with the location data.

The data types 360 refer to the available data types, as a user may decide to show only objects which have a particular data type available or a broadcaster or video provider may require certain data types to always be on. For example, a viewer may decide to be shown only, in a video, indicators where a data type is biographical information. A broadcaster or video provider may however, require all indicators with a data type associated for a salable item (e.g., to purchase a product or service related to the object in the video) shown during the video feed. Referring to the figure, the data types may be, for example, statistics (stats), salable items which may be bought (buy), biographical information (bio), or pictures (pic). The data types 360 and/or associated data may be provided within the feed itself, or may be looked up from a separate lookup table (not shown). For example, referring back to “The Holy Grail” example above, when watching the movie on a DVD disc, when the killer rabbit appears on screen, the associated data may change or be updated at a central location. The biography may be updated or a link to purchase products which were unavailable at the time of manufacture of the DVD may be offered. On an actor's birthday, special, otherwise “hidden” content may be linked via the indicator which isn't available on all other days, and so forth.

It should be noted that the fifth entry shown in FIG. 3 has “N/A” (meaning, “not available” or “not applicable”) in fields 330 through 360. This is because object 110 at time frame 10 2/24 is not visible in the display. The data for object 110 may not be sent or may be indicated with blank, null, or other data indicating that the object is not presently being displayed, but was, is, or will be available again. This is useful if a viewer desires to see a list of all objects at any given time. Further, the data table in FIG. 3 is one of several possible variations that may be used to achieve the goal of creating the selectable indicators on or around the on screen objects.

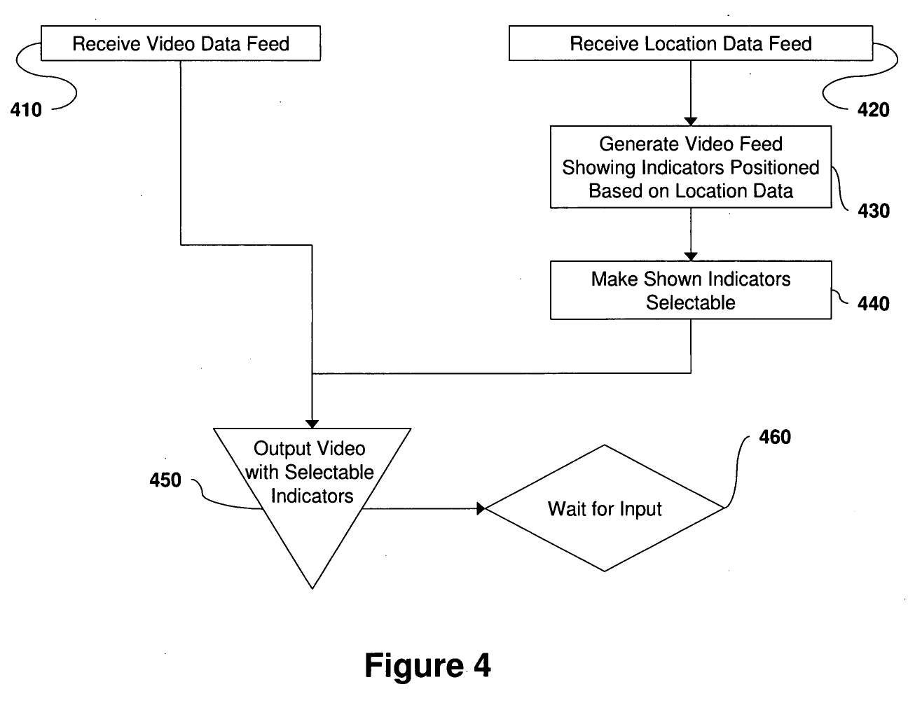

FIG. 4 shows the steps taken to display selectable indicators on a video feed in embodiments of the disclosed technology. In step 410, a video data feed (or video feed or video) is received. This may be by any means known in the art, such as via a radio frequency transmission, data cable (e.g., coaxial, fiber, etc.), from a source disc (e.g., DVD, Blu-Ray, hard disk) to a video playing device, and so forth. Substantially any video feed may be used to carry out embodiments of the disclosed technology. In step 420, a location data feed is received. In a live event, such data may be generated based on GPS or other satellite navigation system data (see U.S. Pat. No. 6,744,403 to Milnes et al. and entitled “GPS Based Tracking System” which is hereby incorporated by reference in its entirety). Proximity sensors, RFID tags, or the like may further be used to provide location data of objects (relative to the image capturing device) in a live event and streamed or broadcast to an interactive video receiving device capable of interpreting the location data and overlaying or modifying the video in received in step 410. (The interactive video receiving device will be described in further detail below.)

In step 430, a video feed is generated with indicators positioned in the video feed based on the location data received in step 420. Thus, data such as that shown in FIG. 3 is received in step 420 and interpreted in step 430, whereby corresponding indicators are placed on each video frame. In step 440, the indicators made selectable, that is, a viewer using a mouse, remote control (e.g., arrow keys), or the like can select one of the indicators and receive further data, such as a menu of selectable information associated with the object chosen or associated data as described herein above.

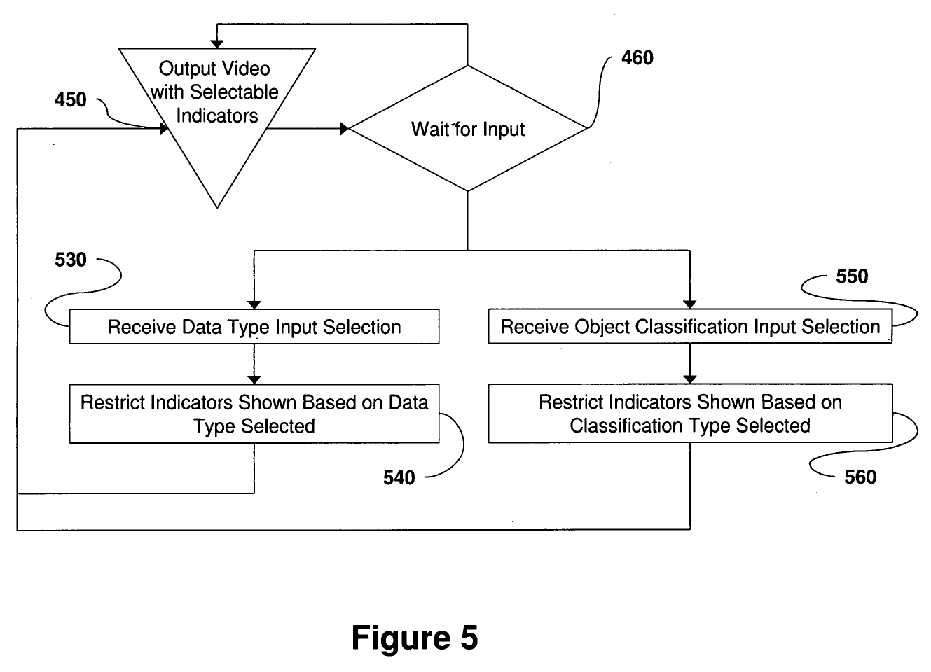

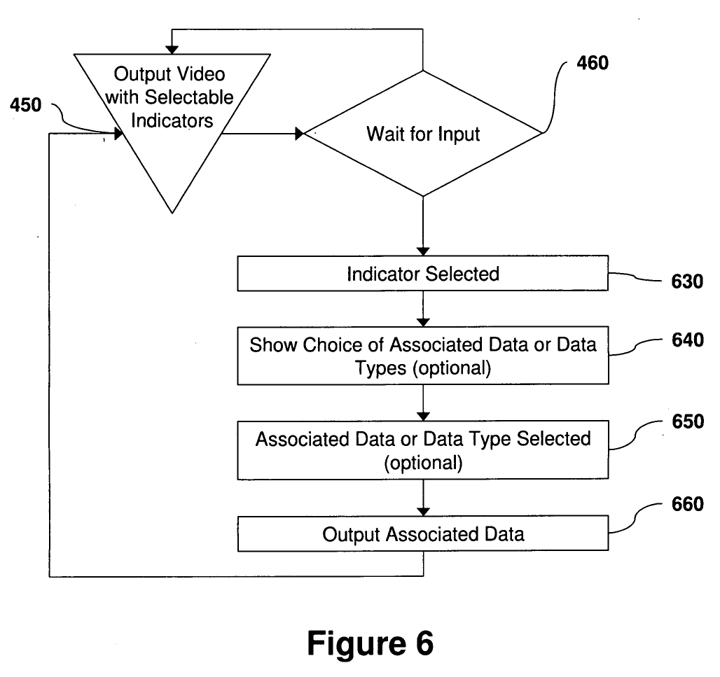

In step 450, the video output of steps 410 (the video feed itself) and step 430 (the indicator video) are merged and a video is outputted to a display with selectable indicators. Thus, a video comprising a frame such as is shown in FIG. 2 is displayed with objects available for selection. Steps 410 through 460 proceed continuously during a length of the video feed (e.g., a plurality of frames). In this manner, in embodiments of the disclosed technology, objects within a video feed (e.g., motion video) are made selectable by way of the selectable indicators. The interactive video receiving device, that is, a video receiving or propagation device, in step 460 waits for input from a user such as a viewer during the video output, as will be shown in FIGS. 5 and 6.

FIG. 5 shows the steps taken to receive a selection of a subset of indicators in an embodiment of the disclosed technology. Referring briefly again to FIG. 1, the objects (e.g., people) may be divided into classifiable sub-groups. By way of example, in FIG. 1, there is a defensive team, offensive team, players on the line of scrimmage, and players in the offensive secondary. Further, there are referees, crowd members (not shown), players on the sidelines (not shown), and so forth. A viewer may desire to have indicators placed on certain objects based on their classification. Referring again to steps 450 and 460 (shown in both FIG. 4 and FIG. 5), in step 450, a video is outputted with selectable indicators as described above. In step 460, while continuing to display/exhibit the combined video feed having at least one selectable indicator of an object displayed, such an interactive video receiving device waits for input from a user.

Either step 530 or 550 may be carried out while the video with selectable indicators is being outputted in step 450 or before the video or the indicators are exhibited/outputted. In step 530, a data type input selection is received by the interactive video device. This is a selection, as described above, such as for showing indicators which lead to the ability for a user to purchase a salable item. As such, in step 540, the indicators are restricted based on the data type selection. For example, referring to FIG. 1, supposing that a data type is “acting career information” and only players 140 and 128 have appeared in commercials, movies, or the like. By the user limiting what is shown of this data type, only the indicators for player 140 and 128 would be shown.

In step 550, which proceeds in a similar manner to step 530, the user limits which indicators are displayed by selecting a classification of the objects to display and such a selection is received by the interactive video device of embodiments of the disclosed technology. In step 560, the indicators shown are restricted to the classification type selected. For example, the user may choose to “turn off” (not show) indicators for backfield, referees, and defensive line of the football game shown in FIG. 1. Thus, indicators 150 and 110 through 128 would not be shown in this example of a still frame of the video shown in FIG. 1.

After completion of either or both steps 540 and 560, step 450 is carried out or continues to be carried out, whereby the video is shown with selectable indicators (if any are available in the data type or classification scheme selected). The video output continues or begins with the indicators which match the criteria selected.

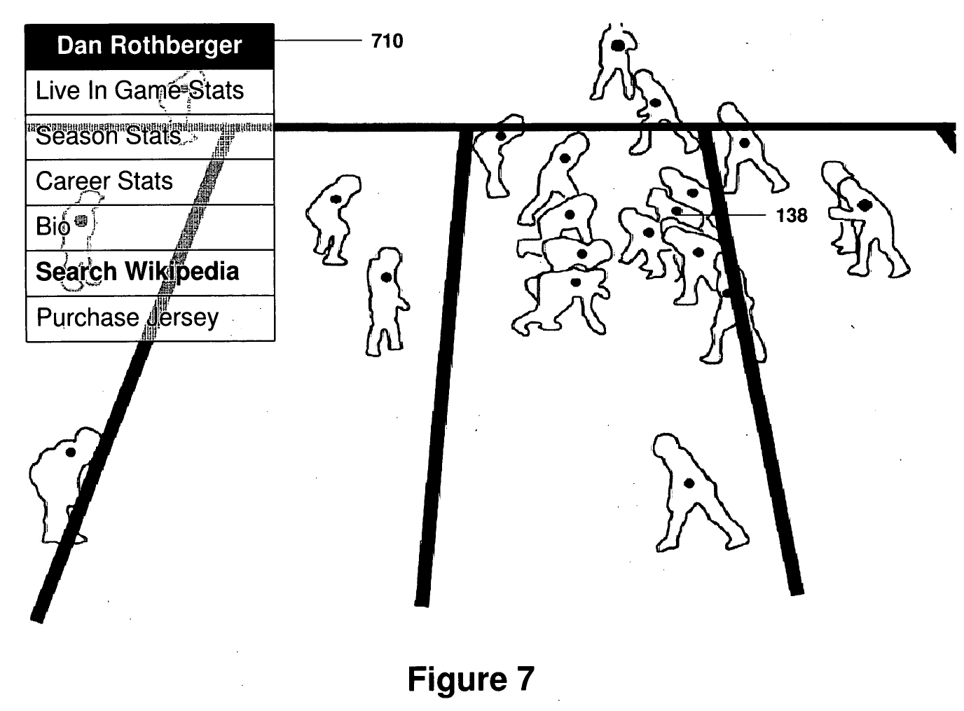

FIG. 6 shows the steps taken to receive data associated with an object in an embodiment of the disclosed technology. Again, steps 450 and 460 from FIG. 4 have been shown in FIG. 6 and remain as described above in FIGS. 4 and 5. When the input received is a selection of an exhibited indicator in step 630, optional steps 640 and 650 are carried out in embodiments of the disclosed technology. That is, in step 640, a choice of associated data or data types is exhibited and then, in step 650, associated data or an associated data type is selected by a user, and such a selection is received by the interactive video device of embodiments of the disclosed technology. In step 660, the associated data which was selected in either step 630 (by way of selecting an indicator) or step 650 is exhibited, such as to a television screen, separate monitor (e.g., part of a personal computer) or the like. A more detailed example of the method shown in FIG. 6 will be described with reference to FIG. 7 below.

FIG. 7 is an example of a video output from a device used to carry out an embodiment of the disclosed technology showing a menu choice of data associated with a selectable object. Referring also to FIG. 6, in step 450, the video, a frame of which is depicted in FIG. 7, is outputted to a video display with at least one selectable indicator. In the state shown in FIG. 7, step 630 has been carried out, whereby an indicator has been selected, in this case, object 138. In an embodiment of the disclosed technology, as a viewer toggles through the objects, an indicator is placed on an object for selection. In other embodiments, all objects with available indicators are shown and one indicator is highlighted and readied for selection.

Upon selection, a menu 710 is presented on the screen (or may be on a separate device or means of exhibiting) in step 640, whereby a choice of associated data is exhibited. The bolded item, “Search Wikipedia” is prepared for selection in step 650. After selection of such data (e.g., “Search Wikipedia”), the associated data, in this case a Wikipedia article on the fictional player “Dan Rothberger,” is exhibited. It should, of course, be understood that this is but one of many examples and uses of the method of FIG. 6.

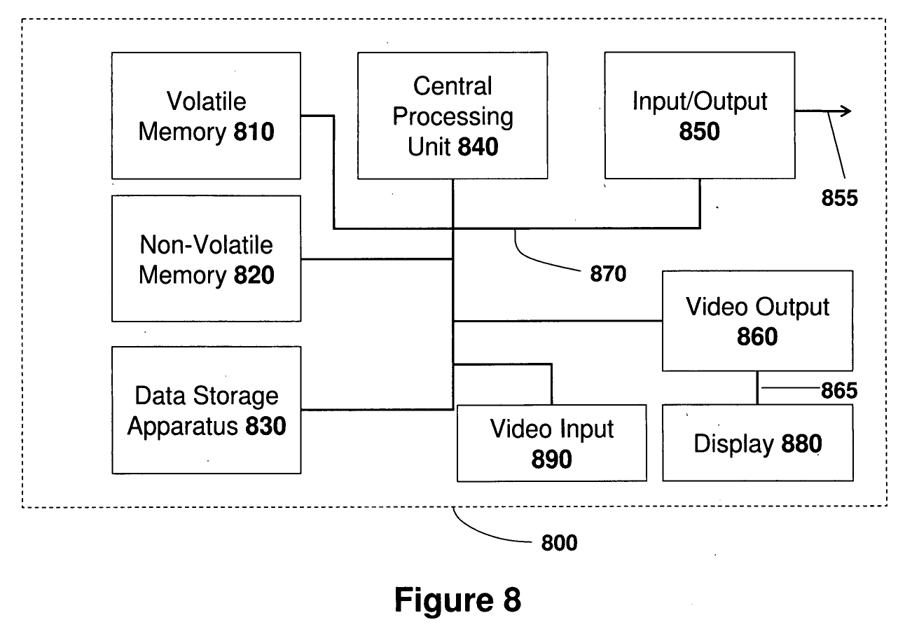

FIG. 8 shows a high level block diagram of an interactive video receiving device on which embodiments of the disclosed technology may be carried out. The device may comprise some or all of the high level elements shown in FIG. 8 and may comprise further devices or be part of a larger device. Data bus 870 transports data between the numbered elements shown in device 800. Central processing unit 840 receives and processes instructions such as code. Volatile memory 810 and non-volatile memory 820 store data for processing by the central processing unit 840.

A video signal may be received from a data storage apparatus 830. The data storage apparatus 830 may be magnetic media (e.g., hard disk, video cassette), optical media (e.g., Blu-Ray or DVD) or another type of storage mechanism known in the art. A video signal may also be received from a video input 890 which may be, for example, a broadcast television signal, a signal via a coaxial or fiber cable, a streamed video over a network such as the internet, and so forth. The video is outputted via a video output 860, that is, a transmitter or video relay device which transmits video to another device such as a television screen, monitor, or other display device 880 via cable or data bus 865. The video output 860 may also be an output over a packet switched network 865, such as the internet, where it is received and interpreted as video data by a recipient device 880.

An input/output device 850, such buttons on the interactive device itself, an infrared signal receiver for use with a remote control, mouse, touch screen, or a network input/output for control via a local or wide area network receives and/or sends a signal via data pathway 855 (e.g., infrared signal, signal over copper or fiber cable, wireless network, etc). The input/output device, in embodiments of the disclosed technology, receives input from a user, such as which indicators to display and what associated data to provide to the user.

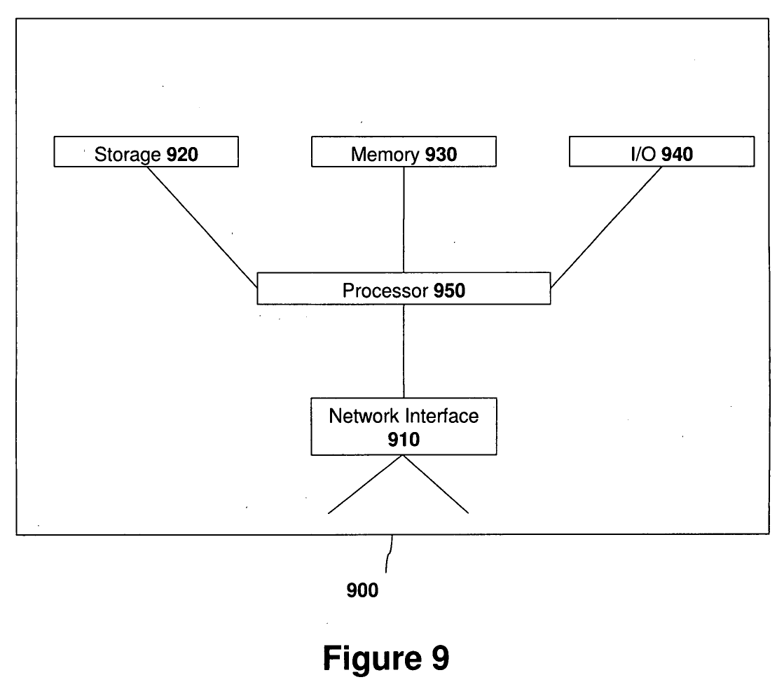

FIG. 9 shows a high-level block diagram of a computer that may be used to carry out the disclosed technology. Computer 900 contains a processor 904 that controls the overall operation of the computer by executing computer program instructions which define such operation. The computer program instructions may be stored in a storage device 908 (e.g., magnetic disk, database) and loaded into memory 912 when execution of the computer program instructions is desired. Thus, the computer operation will be defined by computer program instructions stored in memory 912 and/or storage 908, and the computer will be controlled by processor 904 executing the computer program instructions. Computer 900 also includes one or a plurality of input network interfaces for communicating with other devices via a network (e.g., the internet). Computer 900 also includes one or more output network interfaces 916 for communicating with other devices. Computer 900 also includes input/output 924, representing devices which allow for user interaction with the computer 900 (e.g., display, keyboard, mouse, speakers, buttons, etc.).

One skilled in the art will recognize that an implementation of an actual computer will contain other components as well, and that FIGS. 7 and 8 are high level representations of some of the components of a computer or switch and are for illustrative purposes. It should also be understood by one skilled in the art that the method and devices depicted or described may be implemented on a device such as is shown in FIGS. 8 and 9.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

We claim:

1. A method of providing interactive video, comprising:
exhibiting at least one selectable indicator at a position of an object displayed in a motion video;
receiving a selection of a said selectable indicator; and
exhibiting data associated with said object.

2. The method of claim 1 wherein said motion video is a live broadcast.

3. The method of claim 2, wherein said indicator is positioned on said motion video based on location data received from a sensor on said object.

4. The method of claim 1, wherein said motion video is a recorded video.

5. The method of claim 4, wherein said indicator is positioned on said recorded video based on manual tracking of said object.

6. The method of claim 4, wherein said indicator is positioned on said recorded video based on computer-aided tracking of said object.

7. The method of claim 1, further comprising a step of providing a choice of associated data types before said exhibiting of said data associated with said object.

8. The method of claim 7, wherein said associated data types are selected from the group consisting of biographical information, player statistics, photographs, salable items, and web pages.

9. The method of claim 7, wherein said at least one indicator is a plurality of indicators, each indicator is at a position of a respective object, and a subset of said plurality of indicators is displayed based on a data type available for each said object.

10. The method of claim 1, wherein said indicator surrounds at least a part of said object.

11. The method of claim 10, wherein said indicator is invisible.

12. The method of claim 1, wherein said at least one indicator is a plurality of indicators, each indicator is at a position of a respective object, and a subset of said plurality of indicators is displayed based on an object classification.

13. An interactive video receiving device, comprising:
a video signal propagation mechanism configured to propagate a motion video comprising at least one selectable indicator at a position of an object displayed in a motion video;
an input configured to receive a selection of said at least one selectable indicator;
a display configured to exhibit data associated with said object.

14. The device of claim 13 wherein said motion video is a live broadcast.

15. The device of claim 14, wherein said indicator is positioned on said motion video based on location data received from a sensor on said object.

16. The device of claim 13, wherein said motion video is a recorded video.

17. The device of claim 15, wherein said indicator is positioned on said recorded video based on manual tracking of said object.

18. The device of claim 16, wherein said indicator is positioned on said recorded video based on computer-aided tracking of said object.

19. The device of claim 13, wherein, after receiving a selection, said display is configured to exhibit a choice of data types associated with an object before said configuration to exhibit said data associated with said object.

20. The device of claim 19, wherein said associated data types are selected from the group consisting of biographical information, player statistics, photographs, salable items, and web pages.

21. The device of claim 19, wherein said at least one indicator is a plurality of indicators, each indicator is at a position of a respective object, and a subset of said plurality of indicators is displayed based on a data type available for each said object.

22. The device of claim 13, wherein said indicator surrounds at least a part of said object.

23. The device of claim 13, wherein said indicator is displayed on said object.

24. The device of claim 13, wherein said at least one indicator is a plurality of indicators, each indicator is at a position of a respective object, and a subset of said plurality of indicators is displayed based on an inputted object classification selection.
